(19) United States
(12) Patent Application Publication
(10) Pub. No.: US 2026/0093724 A1
(43) Pub. Date: Apr. 2, 2026

(54) SYSTEMS AND METHODS FOR NORMALIZING RESPONSES FROM LARGE AI MODELS

(71) Applicant: Dealmaker Playbook, Inc., Bakersfield, CA (US)

(72) Inventors: Martin Hansen, Las Vegas, NV (US); Jon Stirling, Hermitage, TN (US); Alana Dobbins, Bakersfield, CA (US)

(21) Appl. No.: 18/905,002

(22) Filed: Oct. 2, 2024

(51) Int. Cl. G06F 16/332; G06F 40/117

(52) U.S. Cl. CPC G06F 16/3329; G06F 40/117

(57) ABSTRACT

The present disclosure describes systems and methods for using a generative pre-trained transformer (GPT) large language model (LLM) to generate an LLM completion response. In some aspects, an application is configured to run on a computing platform and perform communication with the GPT LLM based on a response generation module. Additionally, a database server may store a plurality of databases and is in communication with the application. In some cases, the application may be configured to receive an input comprising a solution type and a text from a user. The application may retrieve, from the database server, a set of prompt sequence instructions that provide instructions for assembling a solution input for the solution type. The GPT LLM takes the assembled solution input as input and generates an LLM completion response.

### BACKGROUND OF THE INVENTION

### 1. Field of the Invention

The present invention relates generally to generative AI, and more specifically to normalizing responses from large AI models.

### 2. Discussion of the Related Art

Various systems and processes are known in the art for normalizing responses from large AI models.

As artificial intelligence (AI) models, particularly large language models (LLMs), continue to advance in size and complexity, they have become increasingly powerful tools across various industries. The AI models are capable of generating text, answering questions, and performing a wide array of tasks with high accuracy.

However, despite the capabilities of the AI models, the responses generated by large AI models can vary widely in terms of quality, tone, and relevance. In some cases, such a variation may arise from differences in the training data, the inherent stochasticity of the models, and the context in which the models are applied. As a result, there is a need in the art for systems and methods that can normalize or standardize the responses from the large AI models, ensuring consistency, reliability, and adherence to desired output formats across diverse applications.

### SUMMARY

The present disclosure describes systems and methods for generating an LLM completion response. Embodiments of the present disclosure may be configured to use a generative pre-trained transformer (GPT) LLM comprising an application and a database server for generating the LLM completion response based on a solution input. In some cases, the database server may receive a user input comprising a solution type and text. For example, the solution input may be assembled based on a set of instructions stored in a database. In some cases, the GPT LLM may generate the response based on receiving the assembled solution input.

An apparatus, system, and method for normalizing responses from large AI models are described. One or more aspects of the apparatus, system, and method include an application configured to run on a computing platform and including a response generation module configured for communication with the GPT LLM and a database server storing a plurality of databases and in communication with the application. In some aspect, the application is configured to run on the computing platform to: receive input from a user, wherein the input includes a solution type; retrieve a set of prompt sequence instructions from at least one database of a plurality of databases, wherein the set of prompt sequence instructions comprises instructions for assembling a solution input for the solution type; assemble the solution input according to the set of prompt sequence instructions, wherein the solution input includes: an AI solution framing prompt for the solution type as a first item of the solution input; at least one supplemental data prompt record, each supplemental data prompt record including specified data from the at least one database, including scoping prompt text for the specified data, the supplemental data prompt record sequenced internally according to the prompt sequence instructions; and ordering of the prompt records according to the prompt sequence instructions; input the solution input to the GPT LLM; and in response to inputting the solution input, receive an LLM completion response from the GPT LLM.

A method, apparatus, non-transitory computer readable medium, and system for normalizing responses from large AI models are described. One or more aspects of the method, apparatus, non-transitory computer readable medium, and system include receiving input from a user, wherein the input includes a solution type; retrieving a set of prompt sequence instructions from at least one database of a plurality of databases, wherein the set of prompt sequence instructions comprises instructions for assembling a solution input for the solution type; assembling the solution input according to the set of prompt sequence instructions, wherein the solution input includes: an AI solution framing prompt for the solution type as a first item of the solution input; at least one supplemental data prompt record, each supplemental data prompt record including specified data from the at least one database, including scoping prompt text for the specified data, the supplemental data prompt record sequenced internally according to the prompt sequence instructions; and ordering of the prompt records according to the prompt sequence instructions; inputting the solution input to the GPT LLM; and receiving, in response to inputting the solution input, the LLM completion response from the GPT LLM.

### BRIEF DESCRIPTION OF THE DRAWINGS

FIG. 1 shows an example of a system for using a GPT LLM to generate an LLM completion response according to aspects of the present disclosure.

FIGS. 2 through 3 show examples of a user interface diagram according to aspects of the present disclosure.

FIG. 4 shows an example of a method for normalizing responses from large AI models according to aspects of the present disclosure.

FIG. 5 shows an example of a method for using a GPT LLM to generate an LLM completion response according to aspects of the present disclosure.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

Foundational models, also known as large artificial intelligence (AI) models, are advanced machine learning or deep learning models trained on extensive and diverse datasets. In some cases, the foundational models, such as GPT-4 and BERT, may be designed to understand and generate human-like text, making such models versatile across various applications. The adaptability provides for the models to perform well in numerous domains, from natural language processing to computer vision, making the models a cornerstone in the development of AI technology.

One of the primary challenges in utilizing large AI models effectively is managing the inconsistency in the responses the models may generate. Due to the vast amount of training data and the probabilistic nature of the models, responses may sometimes be irrelevant, overly verbose, or inconsistent with previous outputs. Such variation in responses may cause issues, particularly in critical applications such as customer support, legal advice, or medical recommendations, where uniformity and accuracy are essential. Existing methods of controlling model outputs, such as fine-tuning or prompt engineering, may be insufficient to completely address the variability and inconsistency issues.

In some cases, obtaining consistent answers from generic GPT Large Language Models (LLMs) such as CoPilot or ChatGPT may be challenging due to several inherent design and functionality related aspects. The models may be trained on large datasets from diverse sources which may result in a wide range of possible outputs. In some examples, a slight variation in user input may trigger different pathways through the neural network model which may result in a different response to the user.

Additionally, the context window of the LLMs may be limited, i.e., the LLMs may consider only a certain amount of text at a time which can affect consistency in case the input changes. The stochastic nature of the models may imply that the model may generate a plurality of different outputs (i.e., even with the same input). In some cases, the model may generate a plurality of different outputs in case the model is designed to introduce randomness to avoid deterministic outputs. Furthermore, the interpretation of the input by the model may vary since the nuances of language may lead to different understandings of the same sentence. Additionally, the interpretation of the input may vary since the language may be inherently ambiguous and context-dependent.

In some cases, careful input management and post-processing may be performed to ensure consistency in the responses and to align the response with the expected consistency. Therefore, existing systems may not be able to normalize and standardize responses from large AI models. In some cases, due to the different responses, such systems may not be accurate, consistent, and aligned with predefined standards or formats, regardless of variations in input or context.

The present disclosure describes systems and methods for generating an LLM completion response. Embodiments of the present disclosure may be configured to use a generative pre-trained transformer (GPT) LLM comprising an application and a database server for generating the LLM completion response based on a solution input. In some cases, the database server may receive a user input comprising a solution type and text. For example, the solution input may be assembled based on a set of instructions stored in a database. In some cases, the GPT LLM may generate the response based on receiving the assembled solution input.

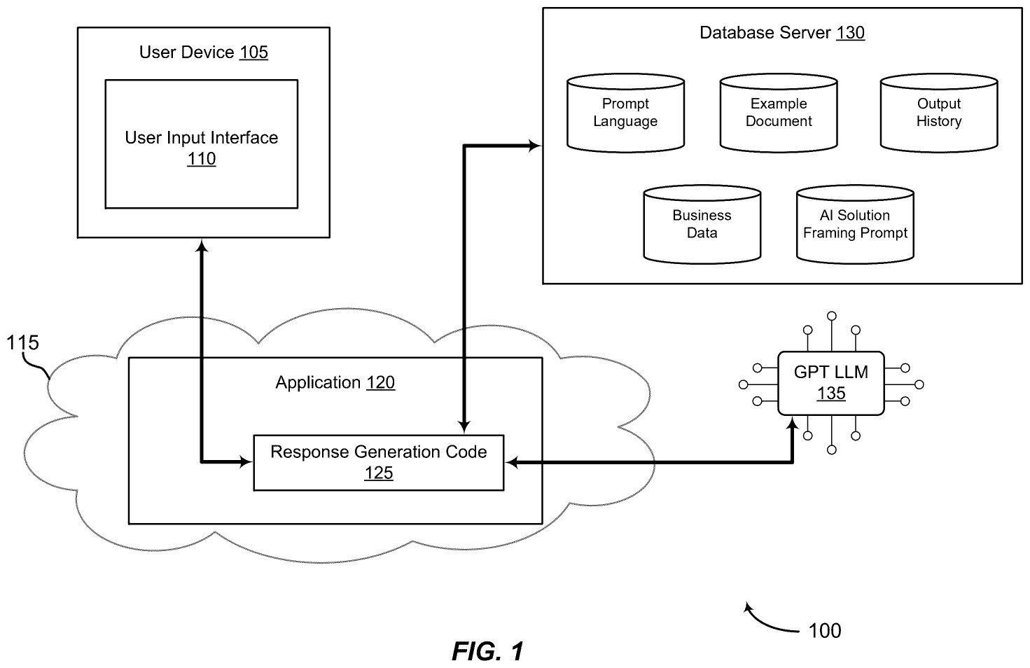

FIG. 1 shows an example of a system 100 for using a GPT LLM 135 to generate an LLM completion response according to aspects of the present disclosure. In one aspect, system 100 includes user device 105, computing infrastructure 115, database server 130, and GPT LLM 135. In one aspect, user device 105 includes user input interface 110.
As used herein, user device 105 may refer to a computing device running a web browser. For example, the user device 105 may be a thin client. In some cases, a user input interface 110 indicates the manner in which information and data may be displayed to the user and input by the user (e.g., display and inputs of a web browser).

In some cases, a GPT LLM 135 may refer to a generative pre-trained transformer (GPT) large language model (LLM) that may be trained on broad data such that the GPT LLM 135 may be applied to a wide range of use cases. In some examples, the GPT LLM 135 may be referred to as a foundational model or a large AI model.

According to some aspects, a transformer comprises one or more ANNs comprising attention mechanisms that enable the transformer to weigh an importance of different words or tokens within a sequence. In some examples, a transformer processes entire sequences simultaneously in parallel, making the transformer highly efficient and allowing the transformer to capture long-range dependencies more effectively.

In some aspects, a transformer comprises an encoder-decoder structure. The encoder of the transformer processes an input sequence and encodes the input sequence into a set of high-dimensional representations. The decoder of the transformer generates an output sequence based on the encoded representations and previously generated tokens. The encoder and the decoder each include one or more layers of self-attention mechanisms and feed-forward ANNs.

The self-attention mechanism allows the transformer to focus on different parts of an input sequence while computing representations for the input sequence. The self-attention mechanism captures relationships between words of a sequence by assigning attention weights to each word based on a relevance to other words in the sequence, thereby enabling the transformer to model dependencies regardless of a distance between words.

An attention mechanism is a key component in some ANN architectures, particularly ANNs employed in natural language processing (NLP) and sequence-to-sequence tasks, which allows an ANN to focus on different parts of an input sequence when making predictions or generating output.

NLP refers to techniques for using computers to interpret or generate natural language. NLP tasks can involve assigning annotation data such as grammatical information to words or phrases within a natural language expression. Different classes of machine-learning algorithms have been applied to NLP tasks. Some algorithms, such as decision trees, utilize hard if-then rules. Other systems use neural networks or statistical models which make soft, probabilistic decisions based on attaching real-valued weights to input features to express the relative probability of multiple answers.

Some sequence models process an input sequence sequentially, maintaining an internal hidden state that captures information from previous steps. However, this sequential processing can lead to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

According to some aspects, an ANN employing an attention mechanism receives an input sequence and maintains the current state, which represents an understanding or context. For each element in the input sequence, the attention mechanism computes an attention score that indicates the importance or relevance of that element given the current state. The attention scores are transformed into attention weights through a normalization process, such as applying a softmax function. The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN.

By incorporating an attention mechanism, an ANN dynamically allocates attention to different parts of the input sequence, allowing the ANN to focus on relevant information and capture dependencies £ across longer distances.

LLMs work by processing vast amounts of text data during the training phase. LLMS learn patterns, relationships between words, and how to predict the next word or phrase based on context. LLMs are trained on enormous datasets, such as books, articles, websites, and other written material and use the data to learn the statistical relationships between words and phrases. Text input is divided into smaller units called tokens, such as words or subwords. Each token has an associated vector representation that the model uses to understand and generate text. The model analyzes sequences of tokens to understand the context of each word or phrase which enables generation of text that is coherent and contextually appropriate.

An AI model may refer to an artificial neural network (ANN). An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the machine learning model can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component may train the machine learning model. For example, parameters of the machine learning model can be learned or estimated from training data and then used to make predictions or perform tasks based on learned patterns and relationships in the data. In some examples, the parameters are adjusted during the training process to minimize a loss function or maximize a performance metric. The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning model can be used to make predictions on new, unseen data (i.e., during inference).

According to an embodiment, an application 120 may refer to a software program designed to interact with an operating system to utilize hardware interfaces for performing specific tasks. In some cases, a web application may refer to a software program that runs on a web server or cloud platform and may be accessed through a web browser over the internet.

In some cases, a computing platform (or computing infrastructure 115) may refer to elements of computing hardware, software, and interfaces that may be used for executing applications (e.g., architecture, OS, and runtime libraries). For example, a computing platform 115 may be a cloud computing platform.

In some cases, a module may refer to a section of code configured to run on a processor. In some cases, an application may include a number of different modules. In some cases, response generation module (e.g., response generation code 125) may refer to the section of code of the application that may determine and assemble the solution input (i.e. sequence of prompts assembled according to prompt sequence instructions). Additionally, the response generation module may send the solution input to the GPT LLM 135 and may receive the LLM completion response from the GPT LLM 135.

In some cases, database server 130 may be a storage for databases. For example, database server may be a relational database server, e.g., SQL server. In some cases, a database may refer to an organized collection of data. For instance, database may include a relational database.

In some cases, previous solution output database may refer to a database that includes each previous solution output with each previous solution output tagged at least by solution type. In some cases, an example document database may refer to a database that may include a library of model/example documents for different solution types. In some cases, a prompt language database may refer to a database that may include a library of scoping prompt text and other prompt language. In some cases, a business data database may refer to a database that may include business data for a business stored by a user (e.g., each business stored by each user). For instance, the business data may be input by the user via the web browser using another module of the application. In some cases, an AI solution framing prompt database may refer to a database that may include a framing prompt for each solution type. The framing prompt may be the initial text prompt in the prompt record. In some cases, the framing prompt may state the solution type and other framing language such as persona.

In some cases, a completion response may refer to text output of GPT LLM 135 (e.g., NAICS code value, executive summary). In some cases, the completion response may be in a format other than plain text (e.g. html). For instance, the completion response may be referred to as LLM completion, LLM completion response, completion result, or response. In some cases, a solution type may refer to a category of desired completion response (e.g., NAICS codes, executive summary, valuation).

In some cases, prompt sequence instructions may refer to a set of instructions that may be used by the response generation module to assemble the solution input. In some cases, the prompt sequence instructions include instructions for the type of data and prompts to be added and the sequence of the prompts and data in the solution input.

In some cases, solution input may refer to an assembled sequential set of text prompts and prompt data that may be input to GPT LLM 135 to obtain a completion response. In some cases, an AI solution framing prompt may refer to an initial text prompt in the prompt sequence. For example, the AI solution framing prompt may state the solution type requested and other framing language (e.g. persona, scope of solution, etc.).

In some cases, prompt data may refer to the text data or file data obtained for including in a solution input. For instance, the prompt data may be supplemental prompt data from a database, the previous completion response output, user textual input from a user, or any other data specified by the prompt sequence instructions.

In some cases, scoping prompt text may refer to text prompt that may provide additional information for the GPT LLM. In some examples, the scoping prompt text may reference prompt data. For example, a scoping prompt may identify an action for the GPT LLM with reference to prompt data and/or may expand or restrict scope of an action.

In some cases, prompt record may refer to prompt data and at least one scoping prompt text for the prompt data. The order of the data and the at least one scoping prompt may be the internal sequence of the prompt record. In some cases, previous solution output may refer to a previous GPT LLM completion response received after submitting a solution input. The previous solution output may be the immediately previous completion response or a completion response from a number of solution inputs ago. In case a number of previous completion responses are stored in a previous solution output database, each previous completion response may be tagged at least by solution type.

In some cases, final document example may refer to a document that may be an example of a desired (i.e. model) output for a particular solution. For instance, the final document example may be stored in the example document database and may be encoded. In some cases, business data may be data for a business of the user. For instance, the business data may have been previously stored in the business data database.

In some cases, textual input may refer to the descriptive information entered by a user as text via the user input interface (e.g. NAICS keywords, business description). For example, a descriptive markup language may be HTML. In some cases, persona prompt may refer to a text prompt that may include specifying a particular role or persona for the LLM to adopt to tailor the response to a specific context or expertise.

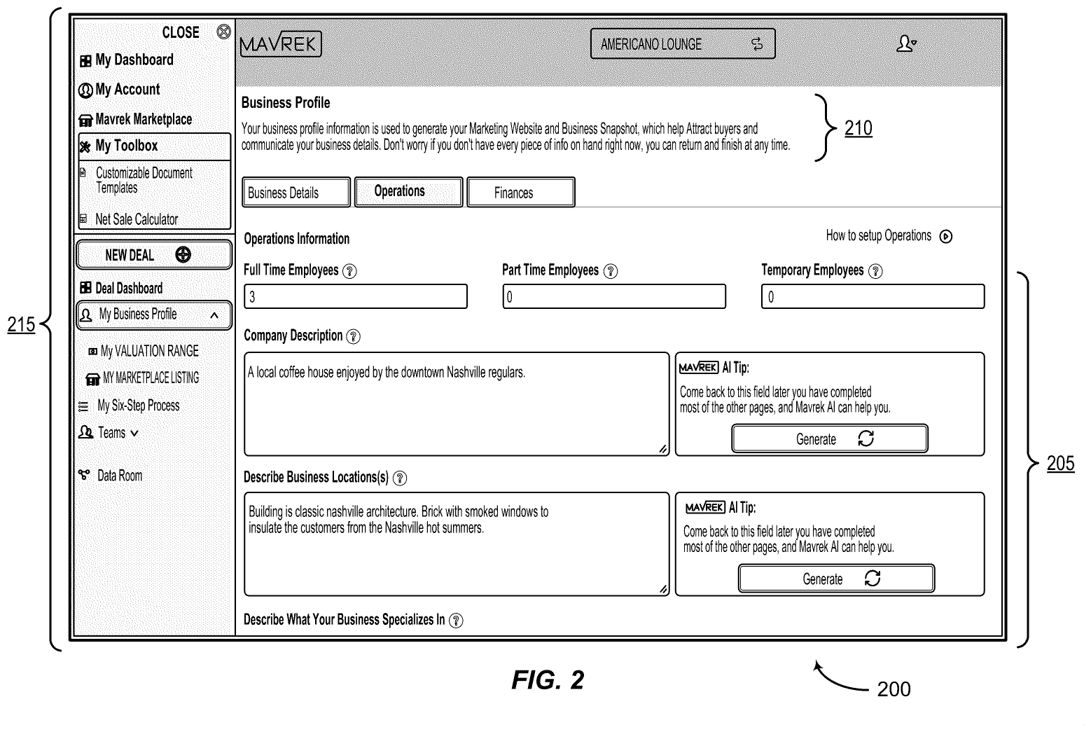

According to some aspects, user input interface 110 is communicatively coupled to the application 120, wherein the user input is received via the user input interface 110. According to some aspects, user input interface 110 receives input from a user, where the input includes a solution type. User input interface 110 is an example of, or includes aspects of, the corresponding element described with reference to FIG. 2.

In one aspect, computing infrastructure 115 includes application 120. According to some aspects, application 120 is configured to run on a computing platform (e.g., computing infrastructure 115) and may include a response generation module (e.g., response generation code 125) configured for communication with the GPT LLM 135.

According to some aspects, application 120 assembles the solution input according to the set of prompt sequence instructions, where the solution input includes: an AI solution framing prompt for the solution type as a first item of the solution input; at least one supplemental data prompt record, each supplemental data prompt record including specified data from the at least one database, including scoping prompt text for the specified data, the supplemental data prompt record sequenced internally according to the prompt sequence instructions; and ordering of the prompt records according to the prompt sequence instructions.

In some examples, application 120 inputs the solution input to the GPT LLM 135. In some examples, application 120 receives, in response to inputting the solution input, the LLM completion response from the GPT LLM 135.

In some aspects the input received from the user input further includes user textual input wherein said assembling of the solution input according to the set of prompt sequence instructions, further comprises said solution input including at least one user textual input prompt record, each user textual input prompt record including at least a portion of the user textual input, including at least one scoping prompt text, the user textual input prompt record sequenced internally according to the prompt sequence instructions. In some aspects, receiving input from the user includes receiving the input from a user input interface 110.

In some aspects the input received from the user further comprises a sequence of solution types, and a plurality of user textual input, wherein each user textual input is associated with one of the sequence of solution types, wherein the system 100 sequentially repeats the steps of retrieving the set of prompt sequence instructions, assembling the solution input, inputting the solution input, and receiving the LLM completion response for each solution type of the sequence of solution types. In some aspects, receiving input from the user includes receiving the input from a user input interface 110.

In some aspects, at least one of the at least one supplemental prompt record includes an example document corresponding to the solution type of the user input supplemental data prompt record and at least one scoping prompt text for the example document, where the example document is an example of a desired tone, language, and structure for the LLM completion for the solution type. In some aspects, receiving input from the user includes receiving the input from a user input interface 110.

In some aspects, at least one supplemental data prompt record of the solution input is a datatype unsuitable for input to the GPT LLM 135, and the method further includes: prior to assembling the solution input, modifying each of the at least one supplemental data prompt record unsuitable for input to the GPT LLM 135 of the solution input to a datatype suitable for input to the GPT LLM 135 prior to assembling the solution input. In some aspects, assembling the solution input further includes at least scoping prompt text including instructions for formatting of the LLM completion. In some aspects, assembling the solution input further includes instructions for formatting the LLM completion using descriptive markup language. In some aspects, at least one scoping prompt text includes instructions defining a persona for the GPT LLM 135. In some aspects, at least one of the at least one supplemental prompt record includes a previous solution output document corresponding to the solution type of the user input supplemental data prompt record and at least one scoping prompt text for the previous solution output document. In some aspects, receiving the input from the user further includes receiving identification of a business associated with the user where at least one of the supplemental prompt record includes business data corresponding to the identified business and at least one scoping prompt text for the business data.

In some examples, application 120 determines, after the step of receiving input from the user, whether at least one database of the set of databases includes a set of prompt sequence instructions for the solution type. In some examples, application 120 proceeds, in response to determining that at least one database of the set of databases includes the set of prompt sequence instructions for the solution type, to the step of retrieving the set of prompt sequence instructions from at least one database of the set of databases. In some examples, application 120 terminates the method in response to determining that at least one database of the set of databases does not include the set of prompt sequence instructions for the solution type. In some aspects, receiving the input from the user further includes receiving a sequence of solution types, and a set of user textual input, where each user textual input is associated with one of the sequence of solution types the method further includes sequentially repeating the steps of retrieving the set of prompt sequence instructions, assembling the solution input, inputting the solution input, and receiving the LLM completion response for each solution type of the sequence of solution types. In one aspect, application 120 includes response generation code 125.

According to some aspects, database server 130 is storing a plurality of databases and in communication with the application 120, wherein the application 120 is configured to run on the computing platform to: receive input from a user, wherein the input includes a solution type; retrieve a set of prompt sequence instructions from at least one database of a plurality of databases, wherein the set of prompt sequence instructions comprises instructions for assembling a solution input for the solution type; assemble the solution input according to the set of prompt sequence instructions, wherein the solution input includes: an AI solution framing prompt for the solution type as a first item of the solution input; at least one supplemental data prompt record, each supplemental data prompt record including specified data from the at least one database, including scoping prompt text for the specified data, the supplemental data prompt record sequenced internally according to the prompt sequence instructions; and ordering of the prompt records according to the prompt sequence instructions; input the solution input to the GPT LLM 135; and in response to inputting the solution input, receive an LLM completion response from the GPT LLM 135.

In some examples, database server 130 comprises (e.g., one of the set of databases includes) an example document database storing a set of example documents where each example document is an example of a desired tone, language, and structure for the LLM completion for one solution type where at least one of the at least one supplemental prompt record includes an example document corresponding to the solution type of the user input supplemental data prompt record and at least one scoping prompt text for the example document. In some aspects, at least one supplemental data prompt record of the solution input is a datatype not suitable for input to the GPT LLM 135 where the application 120 is further configured to modify the at least one supplemental data prompt record of the solution input to a data type suitable for input to the GPT LLM 135 prior to assembling the solution input. In some aspects, at least one scoping prompt text includes instructions for content of the LLM completion. In some aspects, at least one scoping prompt text includes instructions for formatting of the LLM completion. In some aspects, the instructions for formatting of the text response further includes formatting the LLM completion using descriptive markup language.

In some aspects, at least one scoping prompt text includes instructions defining a persona for the GPT LLM 135. In some examples, database server 130 comprises (e.g., one of the set of databases includes) a previous solution output database storing a set of previous solution output documents where each previous solution output document is an LLM completion previously generated by the system 100 where at least one of the at least one supplemental prompt record includes a previous solution output document corresponding to the solution type of the user input supplemental data prompt record and at least one scoping prompt text for the previous solution output document.

In some examples, database server 130 comprises (e.g., one of the set of databases includes) a business data database storing business data for each of a set of businesses where the user input includes identification of a business associated with the user where at least one of the at least one supplemental prompt record includes business data corresponding to the identified business and at least one scoping prompt text for the business data. In some examples, after receiving input from the user (e.g., via user input interface 110), the system 100 determines whether the set of databases includes a set of prompt sequence instructions for the solution type where in response to determining that the set of databases includes the set of prompt sequence instructions for the solution type, the system 100 proceeds to retrieve the set of prompt sequence instructions from at least one database of a set of databases where in response to determining that the set of databases does not include the set of prompt sequence instructions for the solution type, the system 100 terminates the method. In some aspects, the input received from the user further includes a sequence of solution types, where the system 100 sequentially repeats the steps of retrieving the set of prompt sequence instructions, assembling the solution input, inputting the solution input, and receiving the LLM completion response for each solution type of the sequence of solution types.

According to some aspects, database server 130 retrieves a set of prompt sequence instructions from at least one database of a set of databases, where the set of prompt sequence instructions includes instructions for assembling a solution input for the solution type.

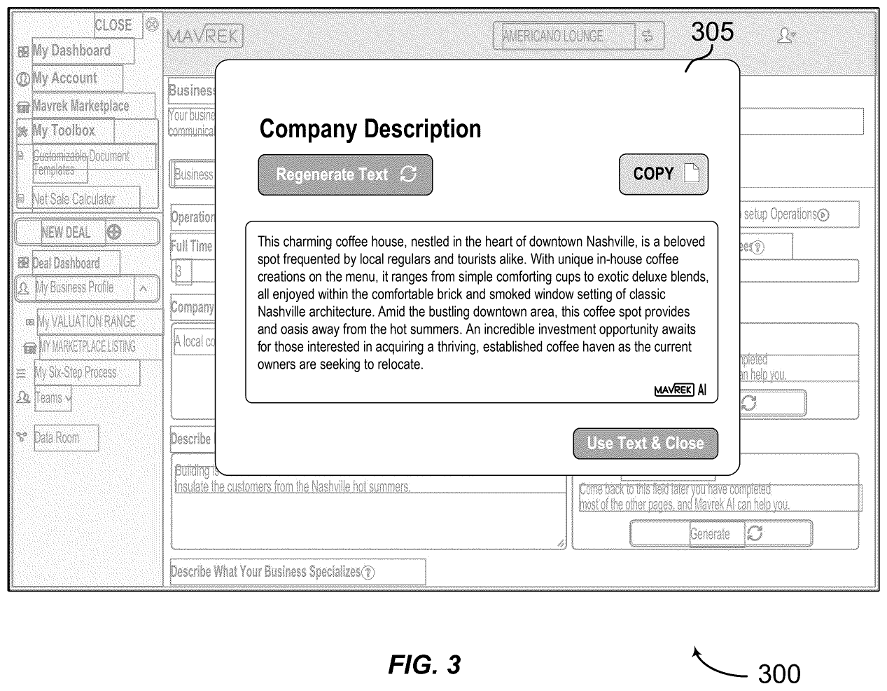

FIG. 2 shows an example of a user interface diagram 200 according to aspects of the present disclosure. User interface diagram 200 is an example of, or includes aspects of, the corresponding element described with reference to FIG. 3. In one aspect, user interface diagram 200 includes user input interface 205, business profile 210, and navigation bar 215. User input interface 205 is an example of, or includes aspects of, the corresponding element described with reference to FIG. 1.

An exemplary embodiment of the present disclosure may be configured to generate an executive summary for a business using a web browser. For instance, a user may enter a descriptive text, i.e., “a local coffee house enjoyed by the downtown Nashville regulars”. For example, the user may enter the descriptive text in the ‘Company Description’ section of the user input interface 205 (such as the user input interface 110 described with reference to FIG. 1). The application may return a more detailed description of the entered text (i.e., in a short time, e.g., within a second) that the user can edit and use as desired.

Referring to FIG. 2, the user interface diagram 200 depicts user input interface 205 that may include options that the user may enter to the system. For instance, user input interface 205 may be configured to receive a user input for generating a summary for a business. For instance, user input interface 205 may include an option for describing a business location (e.g., “Building is classic nashville architecture. Brick with smoked windows to insulate the customers from the Nashville hot summers.” as shown in FIG. 2).

For example, as shown in FIG. 2, business profile 210 may be used to generate a marketing website and a business snapshot. In some cases, the website and the business snapshot may attract a buyer and communicate details of a business.

Referring to FIG. 2, the user interface diagram 200 depicts navigation bar 215 that enables a user to switch between different sections of the website. For instance, navigation bar 215 may include options related to, but not limited to, business profile, user account, dashboard, marketplace, toolbox, etc. In some examples, the toolbox may include customizable document templates and net sale calculator.

FIG. 3 shows an example of a user interface diagram 300 according to aspects of the present disclosure. User interface diagram 300 is an example of, or includes aspects of, the corresponding element described with reference to FIG. 2. In one aspect, user interface diagram 300 includes UI element 305. The UI element 305 may generally refer to any system element for conveying certain information and application functionality to a user, such as a UI window, pop-up window, detailed description window, a company description iteration interface, etc. In the example UI diagram 300, UI element 305 may display a generated company description response generated by the user (via a GPT LLM), UI element 305 may allow a user to alter the response or regenerate a new response, etc., in accordance with one or more aspects described herein.

An embodiment of the present disclosure may be configured to generate a detailed description of the entered text. For instance, the application may be configured to provide a more detailed description in UI element 305 using the text entered by the user (such as the descriptive text entered by the user as described with reference to FIG. 2). In some cases, the detailed description in UI element 305 may be edited or reused as desired by the user.

An embodiment of the present disclosure may be configured to use an AI generation method to generate the more detailed description. For example, the AI method may create executive summary solution input based on a prompt sequence. For instance, the prompt sequence may enable generation of an executive summary for the sale of the business.

In some examples, the executive summary may be used to include (e.g., call out) industry related key words. In some cases, the system may take the business data as input, may generate AI JSON data, and may generate the detailed description. For example, the business data may refer to the data previously entered by the user. In some examples, the business data may be stored in the database. In some examples, the generated AI JSON data may include data which the AI can understand.

In some cases, the detailed description in UI element 305 may be generated based on a previously written document example. For instance, the previously written document example may be stored in the database as an example of the structure of the detailed description document. In some cases, the previously written document example may include information related to the tone and the language to be used in the detailed description in UI element 305.

In some cases, a prompt may be used to create the executive summary with the JSON business data merged with the example document formatting (e.g., the example document formatting may be provided by the user). Next, a prompt (e.g., a plurality of prompts) may be included with special clues related to the output of the GPT LLM. For instance, an initial prompt to the GPT LLM may be: “I want a table of contents, business overview, product lines. And then also talk about the potential business growth opportunities with this business and things of that nature. Also include who the document was prepared by, history and overview section, create two paragraphs”, etc. Accordingly, the said prompt may be provided to the GPT LIM to generate a response. In some cases, the generated response (e.g., the detailed description in UI element 305) may be of a high-quality text that may be used or edited by the user as desired.

According to an example, a solution input (e.g., a prompt sequence) code (such as the pseudo code provided herein) may be provided to the GPT LLM, via a user device, for generating an executive summary.
ChatMessage.FromSystem(“You are a helpful assistant that can take raw JSON data containing great detail of a specified business and compose a response similar to the document format provided.”),
ChatMessage.FromUser(“This is the business data I want you to use in generating the response:”),
ChatMessage.FromUser(AIJsonData),
ChatMessage.FromUser(“This is the document format I want you to use:”),
ChatMessage.FromUser(doc),
ChatMessage.FromUser(“Create a executive summary with the JSON business data provided and document format provided.”),
ChatMessage.FromUser(“The output should contain the following sections: Table of Contents, business overview, product lines (if any), geographical market, customers, competition, key financial breakdown in table form, management team, growth opportunity.”),
ChatMessage.FromUser(“Include a highlight of potential business growth.”),
ChatMessage.FromUser(String. Format (“Include that the document is prepared by {0} {1}, Phone: {2}, Email {3} on the following date: {4} {5}.”,
callingUser.FirstName, callingUser.LastName, callingUser.MobilePhoneNumber, callingUser.Email, DateTime.Now.Month, DateTime.Now.Year)),
ChatMessage.FromUser(“In the History and overview section, create two paragraphs, the first talking about the business, in addition to the information below, add why the company is well positioned in their industry. For the second paragraph, the subject is to talk about the sale of the business, why they are selling, what makes this a good opportunity for a buyer and mention that the owners are willing to remain involved to support a seamless transition.”),
ChatMessage.FromUser(“In the Key Financial breakdown, include language that discusses the last three years of historical financial information in sentence form, include revenue, adjusted EBITDA and the same information for projections for the current year.”),
ChatMessage.FromUser(“output only html as a response. use section headers for each section. Do not include human readable messages regarding the request.”).

In some cases, generation of an appropriate prompt that may provide a helpful response and a consistent and normalized response may be challenging. For instance, generation of an appropriate prompt may be challenging when requesting that a GPT may provide a response and when the LLM may be requested to write text.

The present disclosure provides systems and methods for technical guardrails. In some cases, the guardrail may refer to a limit, constraint, and/or control for narrowing the variability of a response from a generic foundational model. For instance, a small difference in asking a question may result in a different response. In some cases, the responses from the GPT LLM (such as GPT LLM 135 described with reference to FIG. 1) may be normalized for each solution type based on providing a specific set of instructions including specific data and prompt language.

Embodiments of the present disclosure may be configured to define the output of the desired product. In some cases, systems and methods may include focusing and/or limiting the scope of the GPT LLM generative abilities to generate original documents. Additionally, systems and methods may be provided for analyzing/comparing complex document language within a structured ruleset.

An exemplary embodiment of the present disclosure includes a computing architecture based on a generative pre-trained transformer large language model. In some examples, the large language model may be a GPT LLM configured to generate an LLM completion response. According to the exemplary embodiment, the application may be run on the cloud and may include application programming interface (API) and business logic code. In some cases, the user device may be a thin-client running a web-browser. In some cases, the web browser may make an API call (e.g., a plurality of API calls) to the backend of the application. For example, the data may be stored in a SQL server. In some examples, the response generation module of the business logic code may make API calls to the LLM GPT.

According to an embodiment, the user may input information via the display of the web browser and may request for a specific solution type. In some cases, information about the user and a business of the user may be stored in the database server. Accordingly, the response generation module may first check if the database has the instructions to assemble the solution input (i.e., prompt sequence) for the requested solution type. In case the database includes the said instructions, the response generation module may obtain the solution framing prompt language (i.e., a prompt describing the goals of the response). Next, the response generation module may use the instructions to assemble the prompt.

In some cases, the instructions may retrieve data for inclusion in the prompt (e.g., business data or an example document indicating the contents of the response). In some cases, the instructions may retrieve text prompts that provide details restricting or expanding the scope of the response or the data used. Additionally or alternatively, the instructions may use information input by the user via the web browser in combination with other information stored in the database to include in a solution input that is sent to the GPT LLM. In some cases, the application may make an API call to the GPT LLM when the solution input is assembled according to the instructions. Further, the application may send the solution input to the GPT LLM. In some cases, the application may receive the LLM completion from the GPT LLM. In some cases, the application may revise and/or check the LLM completion. Lastly, the application may transmit the final response to the web browser and the response may be displayed to the user via the user interface.

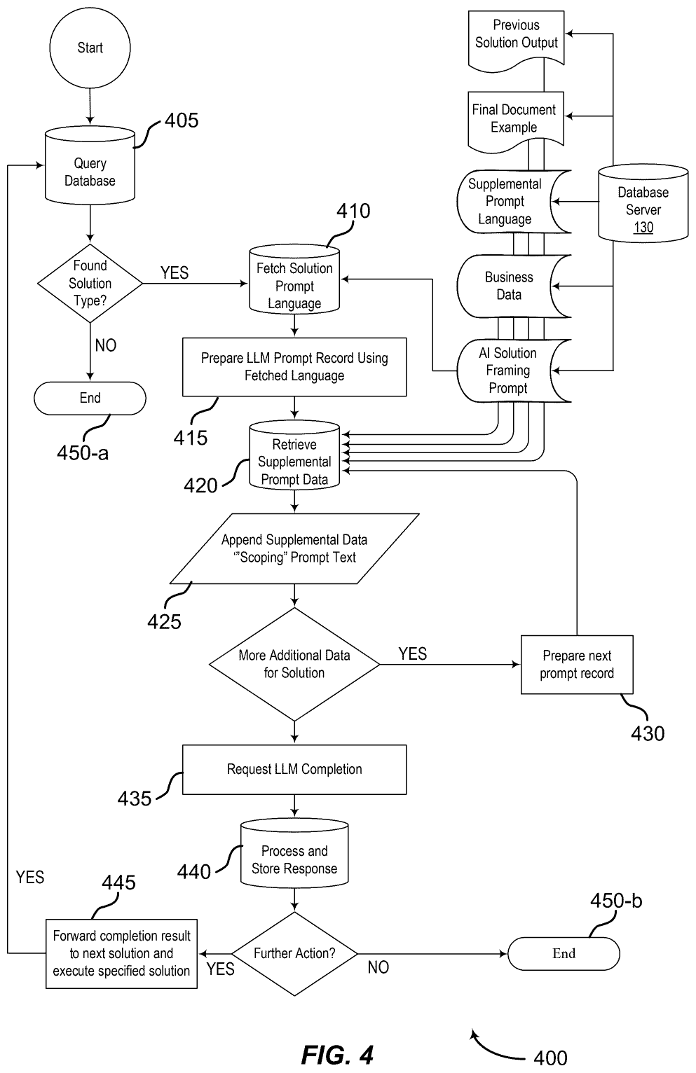

FIG. 4 shows an example of a method 400 for normalizing responses from large AI models according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 405, the system queries database for solution. In some cases, the operations of this step refer to, or may be performed by, an application as described with reference to FIG. 1. In some cases, the operations of this step refer to, or may be performed by, a database server 130 as described with reference to FIGS. 1 and 4.

As shown in FIG. 4, the database server 130 may include a previous solution output database, a final document example database, a supplemental prompt language database, a business data database, and an AI solution framing prompt database.

In some cases, the previous solution output database may refer to a database that includes each previous solution output with each previous solution output tagged at least by solution type. In some cases, the example document database may refer to a database that may include a library of model/example documents for different solution types. In some cases, the prompt language database may refer to a database that may include a library of scoping prompt text and other prompt language. In some cases, the business data database may refer to a database that may include business data for each business stored by each user. For instance, the business data may be input by the user via the web browser using another module of the application. In some cases, the AI solution framing prompt database may refer to a database that may include a framing prompt for each solution type. The framing prompt may be the initial text prompt in the prompt record. In some cases, the framing prompt may state the solution type and other framing language such as persona.

In some cases, the database server 130 may be configured to find a solution type. In cases where the database server 130 identifies (or finds) a solution type, operation 410 may be performed. However, if a solution type is not found, the method 400 may end (i.e., the method 400 may terminate at operation 450-a).

At operation 410, the system fetches solution prompt language. In some cases, the operations of this step refer to, or may be performed by, an application as described with reference to FIG. 1. In some cases, the application may fetch the solution prompt language based on a framing prompt obtained from the AI Solution framing prompt of database server 130 and the solution type.

At operation 415, the system prepares LLM prompt record using fetched language. In some cases, the operations of this step refer to, or may be performed by, an application as described with reference to FIG. 1.

At operation 420, the system retrieves supplemental prompt data. In some cases, the operations of this step refer to, or may be performed by, an application as described with reference to FIG. 1. In some cases, the operations of this step refer to, or may be performed by, a database server 130 as described with reference to FIGS. 1 and 4.

In some cases, the supplemental prompt data may be retrieved based on the prepared LLM prompt record (as described with reference to operation 415), the previous solution output, final document example, supplemental prompt language, business data, AI solution framing prompt, and a subsequent prompt record (e.g., a prompt record prepared as described with reference to operation 430). Further details regarding each of the said components are provided with reference to FIG. 1.

At operation 425, the system appends supplemental data scoping prompt text. In some cases, the operations of this step refer to, or may be performed by, an application as described with reference to FIG. 1.

In some cases, the scoping prompt text may refer to text prompt that may provide additional information for the GPT LLM (such as the GPT LLM 135 described in FIG. 1). In some examples, the scoping prompt text may reference prompt data. For example, a scoping prompt may identify an action for the GPT LLM with reference to prompt data and/or may expand or restrict scope of an action.

At operation 430, the system prepares next prompt record. In some cases, the operations of this step refer to, or may be performed by, an application as described with reference to FIG. 1. In some cases, the next prompt record may be used to retrieve supplemental prompt data (e.g., retrieve data using a retrieval such as that described with reference to operation 420).

For instance, the appending process (such as the process described in operation 425) may result in additional data for solution. In some examples, the additional data for solution may be used to prepare the next prompt record. In some cases, the prompt record may refer to prompt data and at least one scoping prompt text for the prompt data. The order of the data and the at least one scoping prompt may be the internal sequence of the prompt record.

In some examples, one or more of the operations 420-430 may be sequentially performed until there is no additional data for the solution, at which point the method 400 may advance to operation 435. In some cases, there may be no additional data for the solution after operation 425, such that the method advances from operation 425 to operation 435.

At operation 435, the system requests LLM completion. In some cases, the operations of this step refer to, or may be performed by, an application as described with reference to FIG. 1. In some cases, the operations of this step refer to, or may be performed by, a GPT LLM as described with reference to FIG. 1.

At operation 440, the system processes and stores a response (e.g., a completion response, a GPT LIM response, etc.). In some cases, the operations of this step refer to, or may be performed by, an application as described with reference to FIG. 1. In some cases, the operations of this step refer to, or may be performed by, a database server 130 as described with reference to FIGS. 1 and 4.

In some cases, the method 400 may, after operation 440, terminate via operation 450-b. In other cases, method 400 may include further actions (e.g., including forwarding a completion result for a next solution at operation 445). For instance, at operation 445, the system forwards a completion result to next solution and executes a specified solution. In some aspects, operation 405 may again be performed after operation 445. In some cases, the operations of 445 may refer to, or may be performed by, an application as described with reference to FIG. 1.

At operation 450, the system terminates the process. In some cases, the operations of this step refer to, or may be performed by, an application as described with reference to FIG. 1. In some cases, operation 450 may generally include operation 450-a and operation 450-b for terminating the process (e.g., depending on when the method 400 terminates, after operation 405 or after operation 440).

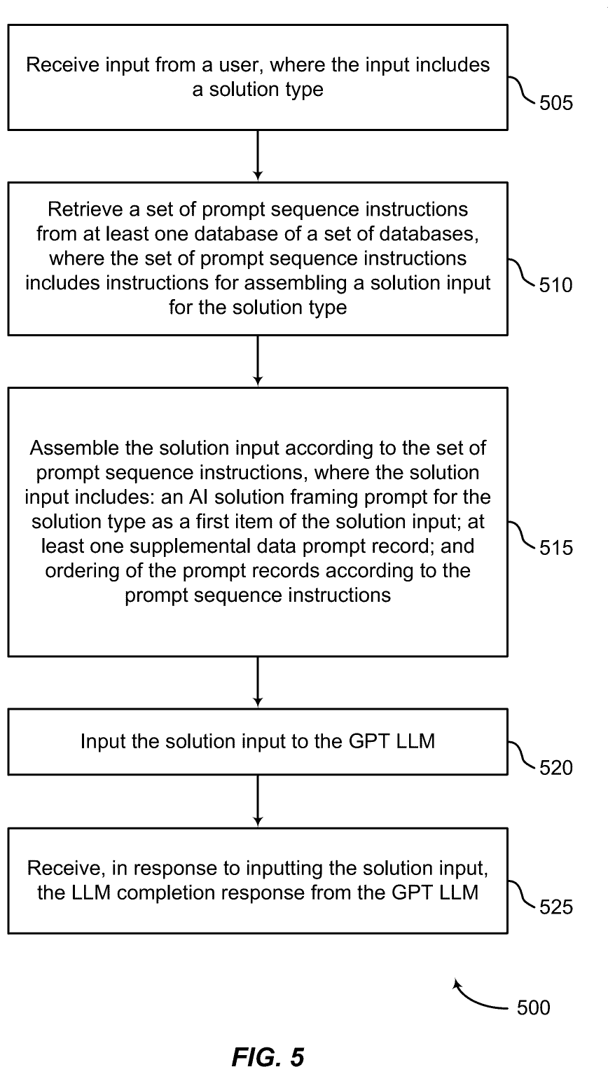

FIG. 5 shows an example of a method 500 for using a GPT LLM to generate an LLM completion response according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 505, the system receives input from a user, where the input includes a solution type. In some cases, the operations of this step refer to, or may be performed by, a user input interface as described with reference to FIGS. 1-3.

At operation 510, the system retrieves a set of prompt sequence instructions from at least one database of a set of databases, where the set of prompt sequence instructions includes instructions for assembling a solution input for the solution type. In some cases, the operations of this step refer to, or may be performed by, a database server as described with reference to FIGS. 1 and 4.

At operation 515, the system assembles the solution input according to the set of prompt sequence instructions. In some aspects, the solution input includes: an AI solution framing prompt for the solution type as a first item of the solution input; at least one supplemental data prompt record, each supplemental data prompt record including specified data from the at least one database, including scoping prompt text for the specified data, the supplemental data prompt record sequenced internally according to the prompt sequence instructions; and ordering of the prompt records according to the prompt sequence instructions. In some cases, the operations of this step refer to, or may be performed by, an application as described with reference to FIGS. 1 and 4.

At operation 520, the system inputs the solution input to the GPT LLM. In some cases, the operations of this step refer to, or may be performed by, an application as described with reference to FIGS. 1 and 4.

At operation 525, the system receives, in response to inputting the solution input, the LLM completion response from the GPT LLM. In some cases, the operations of this step refer to, or may be performed by, an application as described with reference to FIGS. 1 and 4.

Accordingly, an apparatus for normalizing responses from large AI models is described. One or more aspects of the apparatus include an application configured to run on a computing platform and including a response generation module configured for communication with the GPT LLM and a database server storing a plurality of databases and in communication with the application, wherein the application is configured to run on the computing platform to: receive input from a user, wherein the input includes a solution type; retrieve a set of prompt sequence instructions from at least one database of a plurality of databases, wherein the set of prompt sequence instructions comprises instructions for assembling a solution input for the solution type; assemble the solution input according to the set of prompt sequence instructions, wherein the solution input includes: an AI solution framing prompt for the solution type as a first item of the solution input; at least one supplemental data prompt record, each supplemental data prompt record including specified data from the at least one database, including scoping prompt text for the specified data, the supplemental data prompt record sequenced internally according to the prompt sequence instructions; and ordering of the prompt records according to the prompt sequence instructions; input the solution input to the GPT LLM; and in response to inputting the solution input, receive an LLM completion response from the GPT LLM.

In some aspects the input received from the user input further includes user textual input wherein said assembling of the solution input according to the set of prompt sequence instructions, further comprises said solution input including at least one user textual input prompt record, each user textual input prompt record including at least a portion of the user textual input, including at least one scoping prompt text, the user textual input prompt record sequenced internally according to the prompt Sequence instructions.

In some aspects the input received from the user further comprises a sequence of solution types, and a plurality of user textual input, wherein each user textual input is associated with one of the sequence of solution types, wherein the system sequentially repeats the steps of retrieving the set of prompt sequence instructions, assembling the solution input, inputting the solution input, and receiving the LLM completion response for each solution type of the sequence of solution types.

Some examples of the apparatus, system, and method further include one of the plurality of databases is an example document database storing a plurality of example documents wherein each example document is an example of a desired tone, language, and structure for the LLM completion for one solution type wherein at least one of the at least one supplemental prompt record comprises an example document corresponding to the solution type of the user input supplemental data prompt record and at least one scoping prompt text for the example document.

Some examples of the apparatus, system, and method further include a user input interface communicatively coupled to the application, wherein the user input is received via the user input interface.

In some aspects, at least one supplemental data prompt record of the solution input is a datatype not suitable for input to the GPT LLM wherein the application is further configured to modify the at least one supplemental data prompt record of the solution input to a datatype suitable for input to the GPT LLM prior to assembling the solution input.

In some aspects, at least one scoping prompt text includes instructions for content of the LLM completion. In some aspects, at least one scoping prompt text includes instructions for formatting of the LLM completion.

In some aspects, the instructions for formatting of the text response further comprises formatting the LLM completion using descriptive markup language. In some aspects, at least one scoping prompt text includes instructions defining a persona for the GPT LLM.

Some examples of the apparatus, system, and method further include one of the plurality of databases is a previous solution output database storing a plurality of previous solution output documents wherein each previous solution output document is an LLM completion previously generated by the system wherein at least one of the at least one supplemental prompt record comprises a previous solution output document corresponding to the solution type of the user input supplemental data prompt record and at least one scoping prompt text for the previous solution output document.

Some examples of the apparatus, system, and method further include one of the plurality of databases is a business data database storing business data for each of a plurality of businesses wherein the user input includes identification of a business associated with the user wherein at least one of the at least one supplemental prompt record comprises business data corresponding to the identified business and at least one scoping prompt text for the business data.

Some examples of the apparatus, system, and method further include after receiving input from the user, the system determines whether the plurality of databases includes a set of prompt sequence instructions for the solution type wherein in response to determining that the plurality of databases includes the set of prompt sequence instructions for the solution type, the system proceeds to retrieve the set of prompt sequence instructions from at least one database of a plurality of databases wherein in response to determining that the plurality of databases does not include the set of prompt sequence instructions for the solution type, the system terminates the method.

Additionally, a method, apparatus, non-transitory computer readable medium, and system for normalizing responses from large AI models is described. One or more aspects of the method, apparatus, non-transitory computer readable medium, and system include receiving input from a user, wherein the input includes a solution type; retrieving a set of prompt sequence instructions from at least one database of a plurality of databases, wherein the set of prompt sequence instructions comprises instructions for assembling a solution input for the solution type; assembling the solution input according to the set of prompt sequence instructions, wherein the solution input includes: an AI solution framing prompt for the solution type as a first item of the solution input; at least one supplemental data prompt record, each supplemental data prompt record including specified data from the at least one database, including scoping prompt text for the specified data, the supplemental data prompt record sequenced internally according to the prompt sequence instructions; and ordering of the prompt records according to the prompt sequence instructions; inputting the solution input to the GPT LLM; and receiving, in response to inputting the solution input, the LLM completion response from the GPT LLM.

In some aspects, receiving input from the user further comprises the input further including user textual input, and assembling the solution input according to the set of prompt sequence instructions further includes wherein the solution input further includes at least one user textual input prompt record, each user textual input prompt record including at least a portion of the user textual input, wherein the solution input further includes at least one scoping prompt text, wherein the user textual input prompt record is sequenced internally according to the prompt sequence instruction.

In some aspects receiving said input from the user further comprises receiving a sequence of solution types and a plurality of user textual input, wherein each user textual input is associated with one of the sequence of solution types, and further comprises the step of sequentially repeating the steps of retrieving the set of prompt sequence instructions, assembling the solution input, inputting the solution input, and receiving the LLM completion response for each solution type of the sequence of solution types.

In some aspects, at least one of the at least one supplemental prompt record comprises an example document corresponding to the solution type of the user input supplemental data prompt record and at least one scoping prompt text for the example document, wherein the example document is an example of a desired tone, language, and structure for the LLM completion for the solution type. In some aspects, receiving input from the user comprises receiving the input from a user input interface.

In some aspects, at least one supplemental data prompt record of the solution input is a datatype unsuitable for input to the GPT LLM, and the method further comprises: prior to assembling the solution input, modifying each of the at least one supplemental data prompt record unsuitable for input to the GPT LLM of the solution input to a datatype suitable for input to the GPT LLM prior to assembling the solution input.

In some aspects, assembling the solution input further comprises at least scoping prompt text including instructions for formatting of the LLM completion. In some aspects, assembling the solution input further comprises instructions for formatting the LLM completion using descriptive markup language.

In some aspects, at least one scoping prompt text includes instructions defining a persona for the GPT LLM. In some aspects, at least one of the at least one supplemental prompt record comprises a previous solution output document corresponding to the solution type of the user input supplemental data prompt record and at least one scoping prompt text for the previous solution output document.

In some aspects, receiving the input from the user further comprises receiving identification of a business associated with the user wherein at least one of the at least one supplemental prompt record comprises business data corresponding to the identified business and at least one scoping prompt text for the business data.

Some examples of the method, apparatus, non-transitory computer readable medium, and system further include determining, after the step of receiving input from the user, whether at least one database of the plurality of databases includes a set of prompt sequence instructions for the solution type. Some examples further include proceeding, in response to determining that at least one database of the plurality of databases includes the set of prompt sequence instructions for the solution type, to the step of retrieving the set of prompt sequence instructions from at least one database of the plurality of databases. Some examples further include terminating the method in response to determining that at least one database of the plurality of databases does not include the set of prompt sequence instructions for the solution type.

Some of the functional units described in this specification have been labeled as modules, or components, to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

While the invention herein disclosed has been described by means of specific embodiments, examples and applications thereof, numerous modifications and variations could be made thereto by those skilled in the art without departing from the scope of the invention set forth in the claims.

What is claimed is:

1. A system for using a generative pre-trained transformer (GPT) large language model (LLM) to generate an LLM completion response, comprising:
an application configured to run on a computing platform and including a response generation module configured for communication with the GPT LLM; and
a database server storing a plurality of databases and in communication with the application, wherein the application is configured to run on the computing platform to:
receive input from a user, wherein the input includes a solution type;
retrieve a set of prompt sequence instructions from at least one database of a plurality of databases, wherein the set of prompt sequence instructions comprises instructions for assembling a solution input for the solution type;
assemble the solution input according to the set of prompt sequence instructions, wherein the solution input includes:
an AI solution framing prompt for the solution type as a first item of the solution input;
at least one supplemental data prompt record, each supplemental data prompt record including specified data from the at least one database, including scoping prompt text for the specified data, the supplemental data prompt record sequenced internally according to the prompt sequence instructions; and
ordering of the prompt records according to the prompt sequence instructions;
input the solution input to the GPT LLM; and
in response to inputting the solution input, receive an LLM completion response from the GPT LLM.

2. The system for using the generative pre-trained transformer (GPT) large language model (LLM) to generate the LLM completion response of claim 1, further comprising:
wherein the input received from the user further includes user textual input;
wherein said assembling of the solution input according to the set of prompt sequence instructions, further comprises:
said solution input including at least one user textual input prompt record, each user textual input prompt record including at least a portion of the user textual input, including at least one scoping prompt text, the user textual input prompt record sequenced internally according to the prompt sequence instructions.

3. The system for using the generative pre-trained transformer (GPT) large language model (LLM) to generate the LLM completion response of claim 2, further comprising:
wherein the input received from the user further comprises a sequence of solution types, and a plurality of user textual input, wherein each user textual input is associated with one of the sequence of solution types;
wherein the system sequentially repeats the steps of retrieving the set of prompt sequence instructions, assembling the solution input, inputting the solution input, and receiving the LLM completion response for each solution type of the sequence of solution types.

4. The system for using the generative pre-trained transformer (GPT) large language model (LLM) to generate the LLM completion response of claim 1, further comprising:
wherein one of the plurality of databases is an example document database storing a plurality of example documents, wherein each example document is an example of a desired tone, language, and structure for the LLM completion for one solution type; and
wherein at least one of the at least one supplemental prompt record comprises an example document corresponding to the solution type of the user input supplemental data prompt record and at least one scoping prompt text for the example document.

5. The system for using the generative pre-trained transformer (GPT) large language model (LLM) to generate the LLM completion response of claim 1, further comprising:
a user input interface communicatively coupled to the application, wherein the user input is received via the user input interface.

6. The system for using the generative pre-trained transformer (GPT) large language model (LLM) to generate the LLM completion response of claim 1, further comprising:
wherein at least one supplemental data prompt record of the solution input is a datatype not suitable for input to the GPT LLM; and
wherein the application is further configured to modify the at least one supplemental data prompt record of the solution input to a datatype suitable for input to the GPT LLM prior to assembling the solution input.

7. The system for using the generative pre-trained transformer (GPT) large language model (LLM) to generate the LLM completion response of claim 1, further comprising:
wherein at least one scoping prompt text includes instructions for content of the LLM completion

8. The system for using the generative pre-trained transformer (GPT) large language model (LLM) to generate the LLM completion response of claim 1, further comprising:
wherein at least one scoping prompt text includes instructions for formatting of the LLM completion.

9. The system for using the generative pre-trained transformer (GPT) large language model (LLM) to generate the LLM completion response of claim 8, wherein said instructions for formatting of the text response further comprises:
formatting the LLM completion using descriptive markup language.

10. The system for using the generative pre-trained transformer (GPT) large language model (LLM) to generate the LLM completion response of claim 1, further comprising:
wherein at least one scoping prompt text includes instructions defining a persona for the GPT LLM.

11. The system for using the generative pre-trained transformer (GPT) large language model (LLM) to generate the LLM completion response of claim 1, further comprising:
wherein one of the plurality of databases is a previous solution output database storing a plurality of previous solution output documents, wherein each previous solution output document is an LLM completion previously generated by the system; and
wherein at least one of the at least one supplemental prompt record comprises a previous solution output document corresponding to the solution type of the user input supplemental data prompt record and at least one scoping prompt text for the previous solution output document.

12. The system for using the generative pre-trained transformer (GPT) large language model (LLM) to generate the LLM completion response of claim 1, further comprising:
wherein one of the plurality of databases is a business data database storing business data for each of a plurality of businesses;
wherein the user input includes identification of a business associated with the user; and
wherein at least one of the at least one supplemental prompt record comprises business data corresponding to the identified business and at least one scoping prompt text for the business data.

13. The system for using the generative pre-trained transformer (GPT) large language model (LLM) to generate the LLM completion response of claim 1, further comprising:
after the step of receiving input from the user, determining whether the plurality of databases includes a set of prompt sequence instructions for the solution type;
in response to determining that the plurality of databases includes the set of prompt sequence instructions for the solution type, proceeding to the step of retrieving the set of prompt sequence instructions from at least one database of a plurality of databases; and
in response to determining that the plurality of databases does not include the set of prompt sequence instructions for the solution type, terminating the method.

14. The system for using the generative pre-trained transformer (GPT) large language model (LLM) to generate the LLM completion response of claim 1, further comprising:
wherein the input received from the user further comprises a sequence of solution types;
wherein the system sequentially repeats the steps of retrieving the set of prompt sequence instructions, assembling the solution input, inputting the solution input, and receiving the LLM completion response for each solution type of the sequence of solution types.

15. A method for using a generative pre-trained transformer (GPT) large language model (LLM) to generate an LLM completion response, comprising:
receiving input from a user, wherein the input includes a solution type;
retrieving a set of prompt sequence instructions from at least one database of a plurality of databases, wherein the set of prompt sequence instructions comprises instructions for assembling a solution input for the solution type;
assembling the solution input according to the set of prompt sequence instructions, wherein the solution input includes:
an AI solution framing prompt for the solution type as a first item of the solution input;
at least one supplemental data prompt record, each supplemental data prompt record including specified data from the at least one database, including scoping prompt text for the specified data, the supplemental data prompt record sequenced internally according to the prompt sequence instructions; and
ordering of the prompt records according to the prompt sequence instructions;
inputting the solution input to the GPT LLM; and
in response to inputting the solution input, receiving the LLM completion response from the GPT LLM.

16. The method for using the generative pre-trained transformer (GPT) large language model (LLM) to generate the LLM completion response of claim 15, further comprising:
said receiving input from the user, wherein the input further includes user textual input; and
said assembling the solution input according to the set of prompt sequence instructions, wherein the solution input further includes:
at least one user textual input prompt record, each user textual input prompt record including at least a portion of the user textual input, including at least one scoping prompt text, the user textual input prompt record sequenced internally according to the prompt sequence instruction.

17. The method for using the generative pre-trained transformer (GPT) large language model (LLM) to generate the LLM completion response of claim 16, further comprising:
said receiving said input from the user further comprising receiving a sequence of solution types, and a plurality of user textual input, wherein each user textual input is associated with one of the sequence of solution types; and
sequentially repeating the steps of retrieving the set of prompt sequence instructions, assembling the solution input, inputting the solution input, and receiving the LLM completion response for each solution type of the sequence of solution types.

18. The method for using the generative pre-trained transformer (GPT) large language model (LLM) to generate the LLM completion response of claim 15, further comprising:
said assembling the solution input further comprising wherein at least one of the at least one supplemental prompt record comprises an example document corresponding to the solution type of the user input supplemental data prompt record and at least one scoping prompt text for the example document, wherein the example document is an example of a desired tone, language, and structure for the LLM completion for the solution type.

19. The method for using the generative pre-trained transformer (GPT) large language model (LLM) to generate the LLM completion response of claim 15, further comprising:
said receiving input from a user further comprising receiving said input from a user input interface.

20. The method for using the generative pre-trained transformer (GPT) large language model (LLM) to generate the LLM completion response of claim 15, wherein at least one supplemental data prompt record of the solution input is a datatype unsuitable for input to the GPT LLM, further comprising:
prior to assembling the solution input, modifying each of the at least one supplemental data prompt record unsuitable for input to the GPT LLM of the solution input to a datatype suitable for input to the GPT LLM prior to assembling the solution input.

21. The method for using the generative pre-trained transformer (GPT) large language model (LLM) to generate the LLM completion response of claim 15, further comprising:
said assembling said solution input further comprising at least scoping prompt text including instructions for formatting of the LLM completion.

22. The method for using the generative pre-trained transformer (GPT) large language model (LLM) to generate the LLM completion response of claim 21, further comprising:
said assembling said solution input further comprising instructions for formatting the LLM completion using descriptive markup language.

23. The method for using the generative pre-trained transformer (GPT) large language model (LLM) to generate the LLM completion response of claim 15, further comprising:
said assembling said solution input further comprising wherein at least one scoping prompt text includes instructions defining a persona for the GPT LLM.

24. The method for using the generative pre-trained transformer (GPT) large language model (LLM) to generate the LLM completion response of claim 15, further comprising:
said assembling said solution input further comprising wherein at least one of the at least one supplemental prompt record comprises a previous solution output document corresponding to the solution type of the user input supplemental data prompt record and at least one scoping prompt text for the previous solution output document.

25. The method for using the generative pre-trained transformer (GPT) large language model (LLM) to generate the LLM completion response of claim 15, further comprising:
said receiving said input from the user further comprising receiving identification of a business associated with the user; and
assembling said solution input further comprising wherein at least one of the at least one supplemental prompt record comprises business data corresponding to the identified business and at least one scoping prompt text for the business data.

26. The method for using the generative pre-trained transformer (GPT) large language model (LLM) to generate the LLM completion response of claim 15, further comprising:
after the step of receiving input from the user, determining whether at least one database of the plurality of databases includes a set of prompt sequence instructions for the solution type;
in response to determining that at least one database of the plurality of databases includes the set of prompt sequence instructions for the solution type, proceeding to the step of retrieving the set of prompt sequence instructions from at least one database of the plurality of databases; and
in response to determining that at least one database of the plurality of databases does not include the set of prompt sequence instructions for the solution type, terminating the method.

27. The method for using the generative pre-trained transformer (GPT) large language model (LLM) to generate the LLM completion response of claim 15, further comprising:
said receiving said input from the user further comprising receiving a sequence of solution types, wherein each user textual input is associated with one of the sequence of solution types; and
sequentially repeating the steps of retrieving the set of prompt sequence instructions, assembling the solution input, inputting the solution input, and receiving the LLM completion response for each solution type of the sequence of solution types.
